(19) United States
(12) Patent Application Publication
(10) Pub. No.: US 2023/0173936 A1
(43) Pub. Date: Jun. 8, 2023

(54) CHARGING ELECTRIC VEHICLE SUPERCAPACITORS USING SOLAR ENERGY

(71) Applicant: SUSTAINABLE ENERGY TECHNOLOGIES, INC., WILMINGTON, DE (US)

(72) Inventor: John Cronin, WILMINGTON, DE (US)

(21) Appl. No.: 18/076,358

(22) Filed: Dec. 6, 2022

Related U.S. Application Data
(60) Provisional application No. 63/286,413, filed on Dec. 6, 2021.

(51) Int. Cl. B60L 53/51; H02J 7/35; H02J 7/34; B60L 50/40

(52) U.S. Cl. CPC B60L 53/51; B60L 50/40; H02J 7/35; H02J 7/345; G01J 2001/4266

(57) ABSTRACT

Systems and methods for charging electric vehicle supercapacitors using solar energy are disclosed. Systems may include solar cells and solar cells charging controllers that control charging based upon readings of geolocation, related weather forecasts, and shade levels. Such factors may be assessed to determine whether and how to charge the supercapacitors of the electric vehicle. Instructions may be generated regarding such charging and executed accordingly to initiate and optimize electric vehicle supercapacitors charging with solar energy.

### CROSS-REFERENCE TO RELATED APPLICATIONS

The present patent application claims the priority benefit of U.S. Provisional Pat. application no. 63/286,413 filed Dec. 6, 2021, the disclosure of which is incorporated by reference herein.

### BACKGROUND OF THE INVENTION

### 1. Field of the Technology

The present disclosure is generally related to electric vehicle and more specifically to charging electric vehicle supercapacitors using solar energy.

### 2. Description of the Related Art

Electric vehicles (EVs) technologies have grown and evolved exponentially in recent years, and a need for monitoring and managing temperature of power packs in the EVs has also greatly increased over the recent years. EVs, also referred to as battery EVs, generally use a battery pack to store electrical energy that powers a motor of an EV. Further, electric vehicle battery packs are charged by plugging the vehicle into an electric power source. This electric power source may include an external power source or a power charging station. In recent years, there has been a huge increase in the use of electric propulsion in road transport applications, with internal combustion engine hybrid, battery-electric, and fuel cell vehicles with spark-ignition engine hybrids being the most common. This has opened up an opportunity for regenerative braking, whereby the kinetic energy of a vehicle is converted and stored into electrical energy during braking and recycled to reduce fuel consumption in diesel and fuel cell vehicles and extend the range in battery electric vehicles. Batteries are a popular choice due to the widespread use of batteries in hybrid and electric vehicles. Charging electric car batteries may require specialized equipment, which may not be as readily available in certain geographic areas.

There is, therefore, a need in the art for improved system and methods for charging supercapacitor batteries of electric vehicles using solar energy, as well as to optimize extended usage, charge timing, shade management, supercapacitor batteries lifetime, maintenance, speed optimization, energy optimization, and safety concerns.

### SUMMARY OF THE CLAIMED INVENTION

Embodiments of the claimed invention include systems and methods for charging electric vehicle supercapacitors using solar energy. Systems may include solar cells and solar cells charging controllers that control charging based upon readings of geolocation, related weather forecasts, and shade levels. Such factors may be assessed to determine whether and how to charge the supercapacitors of the electric vehicle. Instructions may be generated regarding such charging and executed accordingly to initiate and optimize electric vehicle supercapacitors charging with solar energy.

### BRIEF DESCRIPTIONS OF THE DRAWINGS

FIG. 1 illustrates an exemplary network environment in which a system for charging an electric vehicle using solar cells.

FIG. 2 is a flowchart illustrating an exemplary method for solar charging control.

FIG. 3 is a flowchart illustrating an exemplary method for controlling solar hardware.

FIG. 4 is a flowchart illustrating an exemplary method for charging supercapacitors using solar cells.

FIG. 5 is a flowchart illustrating an exemplary method for solar charging.

FIG. 6 is a flowchart illustrating an exemplary method for geolocation-based charging.

FIG. 7 is a flowchart illustrating an exemplary method for shade-based charging.

### DETAILED DESCRIPTION

Embodiments of the claimed invention include systems and methods for charging electric vehicle supercapacitors using solar energy. Systems may include solar cells and solar cells charging controllers that control charging based upon readings of geolocation, related weather forecasts, and shade levels. Such factors may be assessed to determine whether and how to charge the supercapacitors of the electric vehicle. Instructions may be generated regarding such charging and executed accordingly to initiate and optimize electric vehicle supercapacitors charging with solar energy.

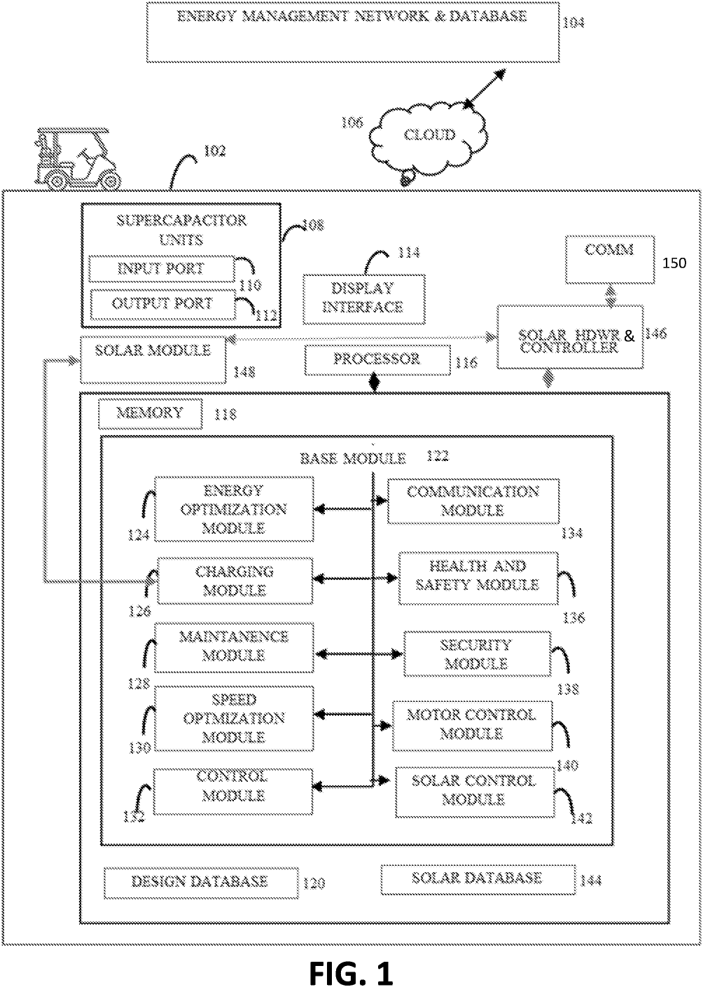

FIG. 1 illustrates an exemplary network environment in which a system for charging an electric vehicle using solar cells. As illustrated, the network environment may include electric vehicle system 102, which may communicate with energy management network database 104 through cloud communication network 106.

As illustrated, electric vehicle system 102 may be installed in or otherwise associated with an electric vehicle, which may correspond to (but is not limited to) a golf cart, an electric car, and an electric bike. Electric vehicle system 102 may include energy storage units of ESU 108 (which may be part of a modular power pack), display interface 114, processor 116, memory 118 (that stores various executable modules 122-142 and databases 120/144), and solar hardware & controller 146, solar module 148, communication interface 150.

Electric vehicle system 102 may be configured to control and enhance capability of the ESU 108, as well as provide a smart energy management system to supply electric charge to the vehicle motor from supercapacitors of ESU 108 in a controlled manner to maximize charge efficiency. Further, the ESU 108 may provide ultra-capacitors with real-time charging and discharging while the electric vehicle is continuously accelerating and decelerating along a predefined path. In one embodiment, the ESU 108 may be referred to as a modular graphene supercapacitor power pack for powering the electric vehicle.

The ESU 108 is a device that can store and deliver charge. It may include one or more power packs which in turn may include supercapacitor units. The ESU 108 may also include batteries, hybrid systems, fuel cells, etc. Capacitance provided in the components of the ESU 108 may be in the form of electrostatic capacitance, pseudocapacitance, electrolytic capacitance, electronic double-layer capacitance, and electrochemical capacitance, and a combination thereof, such as both electrostatic double-layer capacitance and electrochemical pseudocapacitance, as may occur in supercapacitors. The ESU 108 may be associated with or include control hardware and software with suitable sensors, as needed, for an energy control system to manage any of the following: temperature control, discharging of the ESU 108 whether collectively or of any of its components, charging of the ESU 108 whether collectively or of any of its components, maintenance, interaction with batteries, battery emulation, communication with other devices, including devices that are directly connected, adjacent, or remotely such as by wireless communication, etc. In some aspects, the ESU 108 may be portable and provided in a casing containing at least some components of the energy control system and features such as communication interface 150, a display interface 114, etc.

Supercapacitor units may include an ultracapacitor, which is an electrical component capable of holding hundreds of times more electrical charge quantity than a standard capacitor. This characteristic makes ultracapacitors useful in devices that require relatively little current and low voltage. In some situations, an ultracapacitor can take the place of a rechargeable low-voltage electrochemical battery.

Supercapacitor units (including ultracapacitors) typically have high power density, meaning they can charge up quickly and discharge quickly. The load curve of a chemical battery typically shows a high energy density, meaning such battery is very stable upon discharge (e.g., voltage does not change much over time for a given load) for long periods of time. This means that the chemical battery (e.g., lead acid or lithium ion, etc.) has a high energy density but they have a low power density, meaning they charge slowly. Ultracapacitors or supercapacitors units have been developed recently that have both a high power density (charge fast) and a high energy density (discharge slowly). An ultracapacitor or supercapacitor unit that has both a high power density and a high energy density with a load discharge curve that resembles or comes close to a load discharge curve of a chemical battery, is ideal. As used herein, supercapacitor refers generically to all forms of supercapacitors, but ideally one that has both high power density as well as high energy density.

The energy control system may combine hardware and software (e.g., one or more modules 122-142/148) that manages various aspects of the ESU 108, including its energy to the device. The energy control system regulates the ESU 108 to control discharging and charging (whether collectively or of any of its components), and other features as desired, such as temperature, safety, efficiency, temperature control, maintenance, interaction with batteries, or battery emulation, communication with other devices, including devices that are directly connected, adjacent, or remotely such as by wireless communication, etc. The ESU 108 may be adapted to give the energy control system individual control over each power pack or optionally over each supercapacitor or grouped supercapacitor unit to tap the available power of individual supercapacitors efficiently and to properly charge individual supercapacitors rather than merely providing a single level of charge for the ESU 108 as a whole that may be too little or too much for individual supercapacitors or their power packs.

The energy control system may include one or more modules 122-142/148 that the processor 116 can execute or govern according to code stored in a memory 118 such as a chip, a hard drive, a cloud-based source, or another computer-readable medium. Thus, the energy control system may include or be operatively associated with a processor 116, a memory 118 that includes code for the controller (e.g., modules 122-142/148), a database 120/144, and communication interfaces and tools 150 such as a bus or wireless capabilities for interacting with an interface 114 or other elements or otherwise providing information, information requests, or commands. The energy control system may interact with individual power packs or supercapacitors through a crosspoint switch or other matrix systems. Further, the energy control system may obtain information from individual power packs or their supercapacitors through similar switching mechanisms or direct wiring in which, for example, one or more of a voltage detection circuit, an amperage detection circuit, a temperature sensor, and other sensors or devices may be used to provide details on the level of charge and performance of the individual power pack or supercapacitor.

As illustrated, ESU 108 may correspond to supercapacitor units of ESU 108, which may be inclusive of, for example, is a 21,000 F 4.2 V nano-pouch graphene energy module with a final 48 V 100 AH Graphene Power Pack. The 21,000 F 4.2 V nano-pouch graphene energy modules may contain many layers of a graphene lattice matrix structure deposited using a unique method of electropolymerization that provides a highly dense energy storage module design with high-current energy transfer. Due to the tightly coupled nanotechnology design and manufacturing methods, energy storage and delivery can be cycled thousands of times without matrix degradation. This power pack is a capacitive battery substitute in nature, graphene-based, and contains no lithium or other chemical conversion components. In one embodiment, the plurality of supercapacitor units of ESU 108 may be continuously charged in real-time, depending upon the usage of the electric vehicle system 102, such as through the use of solar panels, inductive charging, etc., and optionally by redistributing charge among individual supercapacitors or supercapacitor units (a single supercapacitor unit of ESU 108 may include multiple supercapacitors internally). Alternatively or in addition, supercapacitor units of ESU 108 may be charged while connected to a suitable charging source such as an AC power line (not shown) or DC power (not shown) n alternative energy source such as solar power, wind power, etc., where a trickle charging system may be applied.

The charging and discharging hardware of ESU 108 may include the wiring, switches, charge detection circuits, current detection circuits, and other devices for proper control of charge applied to the power packs or the batteries or other energy storage units and temperature-control devices such as active cooling equipment and other safety devices. Active cooling devices (not shown) may include fans, circulating heat transfer fluids that pass through tubing or, in some cases, surround or immerse the power packs, thermoelectric cooling such as Peltier effect coolers, etc.

To charge and discharge an individual unit among the power packs to optimize the overall efficiency of the ESU 108, methods are needed to select one or more of many units from what may be a three-dimensional or two-dimensional array of connectors to the individual units. Any suitable methods and devices may be used for such operations, including crosspoint switches or other matrix switching tools. Crosspoint switches and matrix switches are means of selectively connecting specific lines among many possibilities, such as an array of X lines (X1, X2, X3, etc.) and an array of Y lines (Y1, Y2, Y3, etc.) that may respectively have access to the negative or positive electrodes or terminals of the individual units among the power packs as well as the batteries or other energy storage units. SPST (Single-Pole Single-Throw) relays, for example, may be used. By applying a charge to individual supercapacitors within power packs or to individual power packs within the ESU 108, a charge can be applied directly to where it is needed, and a supercapacitor or power pack can be charged to an optimum level independently of other power packs or supercapacitors.

Further, ESU 108 may include an input port 110 and an output port 112. Further, the input port 110 may be provided to charge the plurality of supercapacitor units of ESU 108. The output port 112 may be provided to connect the plurality of supercapacitor units of ESU 108 to the electric vehicle system 102 or any other device. Input port 110 and output port 112 may be used for testing the supercapacitor unit of ESU 108. In one embodiment, the output port 112 may be provided with a connector to connect the plurality of supercapacitor units of ESU 108 to the electric vehicle system 102. In one embodiment, each of the plurality of supercapacitor units of ESU 108 may include a plurality of power pack units coupled to each other in series or parallel. In one embodiment, the plurality of supercapacitor units of ESU 108 may enhance the performance of the electric vehicle system 102 by supplying the electric charge according to the desired need of the electric vehicle system 102.

The input port 110 and output port 112 can receive charge from a device (or a plurality of devices in some cases) such as the grid or regenerative power sources in an electric vehicle (not shown) and can deliver charge to a device such as an electric vehicle (not shown). The input port 110 and output port 112 may include one or more inverters, charge converters, or other circuits and devices to convert the current to the proper type (e.g., AC or DC) and voltage or amperage for either supplying power to or receiving power from the device it is connected to.

The input port 110 and output port 112 may be adapted to receive power from various power sources, such as via two-phase or three-phase power, DC power, etc. input port 110 and output port 112 may respectively receive and provide power by wires, inductively, or any other proper means. Converters, transformers, rectifiers, and the like may be employed as needed. The power received may be relatively steady from the grid, or other sources at voltages such as 110 V, 120 V, 220 V, 240 V, etc., or from highly variable sources such as solar or wind power amperage or voltage vary. DC sources may be, by way of example, from 1V to 0V or higher, such as from 4 V to 200 V, 5 V to 120 V, 6 V to V, 2 V to 50 V, 3 V to 24 V, or nominal voltages of about 4, 6, 12, 18, 24, 30, or 48 V. Similar ranges may apply to AC sources, but also including from 60 V to 300 V, from 90 V to 250 V, from V to 240 V, etc., operating at any proper frequency such as 50 Hz, 60 Hz, Hz, etc.

Power received or delivered via input port 110 and output port 112 may be modulated, converted, smoothed, rectified, or transformed in any useful way to meet better the application’s needs and the requirements of the device and the ESU. For example, pulse-width modulation (PWM), sometimes called pulse-duration modulation (PDM), may be used to reduce the average power delivered by an electrical signal as it is effectively chopped into discrete parts. Likewise, maximum power point tracking (MPPT) may be employed to keep the load at the right level for the most efficient power transfer. The input port 110 and output port 112 may have a plurality of receptacles of receiving power and a plurality of outlets for providing power to one or more devices. Conventional AC outlets may include any known outlet standard in North America, various parts of Europe, China, Hong Kong, etc.

Electric vehicle system 102 may further include a display interface 114 for displaying information, notifications, etc. The display interface 114 may be displayed on or in the device, such as on a touch screen or other display in a vehicle or on the device, or it may be displayed by a separate device such as the user’s phone. The display interface 114 may include or be part of a graphic user interface such as the vehicle’s control panel (e.g., a touch panel). The display interface 114 may also include audio information and verbal input from a user. It may also be displayed on the ESU itself or a surface connected to or communicated with the ESU. In one version, the display interface 114 may include but is not limited to a video monitoring display, a smartphone, a tablet, and the like, each capable of displaying a variety of parameters and interactive controls. Still, the display interface 114 could also be as simple as one or more lights indicating charging or discharging status and optionally one or more digital or analog indicators showing remaining useful lifetime, % power remaining, voltage, etc.

Further, the display interface 114 may be any state-of-the-art display means without departing from the scope of the disclosure. In some aspects, the display interface 114 provides graphical information on charge status, including one or more fractions of charge remaining or consumed, remaining useful life of the ESU or its components (e.g., how many miles of driving or hours of use are possible based on current or projected conditions or based on an estimate of the average conditions for the current trip or period of use), and may also provide one or more user controls to allow selection of settings. Such settings may include low, medium, or high values for efficiency, power, etc.; adjustment of operating voltage when feasible; safety settings (e.g., prepare the ESU for shipping, discharge the ESU, increase active cooling, only apply low power, etc.); planned conditions for use (e.g., outdoors, high-humidity, in the rain, underwater, indoors, etc.). Selections may be made through menus and buttons on a visual display, through audio “display” of information responsive to verbal commands, or through text commands or displays transmitted to a phone or computer, including text messages or visual display via an app or web page.

For example, information regarding the charging and discharging, temperature, etc., of each of the plurality of supercapacitor units of ESU 108 may be displayed over a display interface 114. In one embodiment, the display interface 114 may be integrated within the electric vehicle system 102. The display interface 114 may be, but is not limited to, a video monitoring display, a smartphone, and a tablet, each capable of displaying a variety of parameters and interactive controls, but could also be as simple as one or more lights indicating charging or discharging status and optionally one or more digital or analog indicators showing remaining useful lifetime, % power remaining, voltage, etc. Thus, display interface 114 may be coupled to the processor 116 to continuously display the status of charging and discharging the plurality of power packs.

Electric vehicle system 102 may further be operatively associated with a processor 116, which may be included within the electric vehicle system 102 or integrated within the casing or other components or may have components distributed in two or more locations. The processor 116 may include one or more microchips or other systems for executing electronic instructions and can provide instructions to regulate the charging and discharging hardware and, when applicable, the configuration hardware or other aspects of the ESU 108 and other aspects of the energy control system and its interactions with the device, the cloud communication network 106, etc. In some cases, a plurality of processors 116 may collaborate, including processors installed with the ESU 108 and processors installed in a vehicle or other device.

Processor 116 may be configured to execute software instructions, including instructions relating to any of modules 122-142. Execution of such instructions by the processor 116 may further result in generation and communication of generated instructions to the electric vehicle system 102, the plurality of supercapacitor units of ESU 108 (e.g., based on information from the energy management database), the terrain or route, and other parameters via the cloud communication network 106 and other remote sources (e.g., energy management network database 104). In one embodiment, the retrieved information related to the electric vehicle system 102 may be stored in real-time into the memory 118.

Memory 118 may store coding for operation of one or more of the modules 122-142 and their interactions with each other or other components. Memory 118 may also include information such as databases 120/144 pertaining to any aspect of the operation of the electric vehicle system 102, though additional databases may also be available via the cloud (e.g., cloud communication network 106). The memory 118 may store data in one or more locations or components such as a memory chip, a hard drive, a cloud-based source or other computer readable medium, and may be in any useful form such as flash memory, EPROM, EEPROM, PROM, MROM, etc., or combinations thereof and in consolidated (centralized) or distributed forms. The memory may in whole or in part be read-only memory (ROM) or random-access memory (RAM), including static RAM (SRAM), dynamic RAM (DRAM), synchronous dynamic RAM (SDRAM), and magneto-resistive RAM (MRAM), etc.

Such databases stored in memory 118 can include a design database 120 that describes various charge management parameters relating to the charging and/or discharging characteristics of a plurality or all of the energy sources (the power packs and the batteries or other energy storage units ), for guiding charging and discharging operations. Such data may also be included with energy-source-specific data provided by or accessed by the energy source modules. Memory 118 may be configured to store and retrieve information related to the performance of the electric vehicle system 102 from the design database 120. In one embodiment, the design database 120 may be configured to store the consumption of electric charge per unit per kilometer drive of the electric vehicle system 102. For example, an electric vehicle 1 with ten supercapacitor units installed consumes 5 kW/h of electric charge for one hour to drive the electric vehicle 1 for a distance of one kilometer at a characteristic speed of 7 m/s (about 16 mph) with an initial acceleration of, say, 23 M/s2. Further, for an electric vehicle 2 with 15 supercapacitor units installed, it consumes 8 kW/h of electric charge for one hour to drive the electric vehicle 2 for a distance of one kilometer with an acceleration of 42 m/s2. Further, for an electric vehicle 3 with 13 supercapacitor units installed, it consumes 4 kW/h of electric charge for one hour to drive the electric vehicle 3 for a distance of one kilometer with an acceleration of 26 m/s2. Further, for an electric vehicle 4 with 12 supercapacitor units installed, it consumes 3 kW/h of electric charge for one hour to drive the electric vehicle 4 for a distance of one kilometer with an acceleration of 24 m/s2. Further, for an electric vehicle 5 with 20 supercapacitor units installed, it consumes 10 kW/h of electric charge for one hour to drive the electric vehicle 5 for a distance of one kilometer with an acceleration of 46 m/s2.

Memory 118 may also store a plurality of modules 122-142 to evaluate and enhance the performance of the electric vehicle system 102. For example, a base module 122 may be communicatively coupled to the processor 116 and may reside in whole or in part in memory 118. In one embodiment, the base module 122 may act as a central module to receive and send instructions to/from each of the plurality of other modules 124-142. In one embodiment, the base module 122 may be configured to manage at least two parameters related to the electric vehicle system 102, such as, but are not limited to, electric charge of the plurality of supercapacitor units of ESU 108 and the performance of the electric vehicle upon receipt of a predefined amount of electric charge from the plurality of supercapacitor units of ESU 108

Further, the base module 122 may include and operate an energy optimization module 124 to optimize the electric charge of the plurality of supercapacitor units of ESU 108. In one embodiment, the energy optimization module 124 may be configured to determine the percentage of electric charge available in each of the plurality of supercapacitor units of ESU 108. In another embodiment, the energy optimization module 124 may be configured to collect data related to each of the plurality of supercapacitor units of ESU 108 required for one run time of the electric vehicle system 102 along the predefined path. The energy optimization module 124 is designed to rely on supercapacitors’ premeasure performance, such as the charge curve over time and the discharge curve overtime at various loads. Once this premeasured performance is defined, it is stored in a database 120/144.

The energy optimization module 124 may also rely on other curves such as, but not related to voltage vs. current charge and discharge curves, temperature as a discharge function under various loads, humidity versus storage time as a particular voltage, etc. The Energy Optimization module may, for example, evaluate the future load prediction due to a user-defined map, where the energy optimization module 124 may determine that 5 out of 10 batteries would be sufficient for the prediction, so the energy optimization module 124 determinations may inform which batteries may be used for the predicted trip. The energy optimization module 124, using capacitor premeasurements, may determine that even though 5 out of 10 batteries would be sufficient for the preplanned trip, that 7 of the ten supercapacitor batteries are used, leaving 7 of 10 batteries with usable future charge and 3 of the ten batteries left fully charges in case there is a deviation from the planned trip.

The energy optimization module 124 could refine preplanned route optimization or route optimization in many ways, including but not limited to application of artificial intelligence/machine learning of historical data, historical data on actual use of a common route, etc. As such, beyond relying on static information in databases, in some aspects, the energy optimization module 124 may be adapted to perform machine learning and to learn from situations faced constantly. In related aspects, the processor 116 and the associated software (e.g., energy optimization module 124) may form a “smart” controller based on machine learning or artificial intelligence adapted to handle a wide range of input and a wide range of operational demands.

For example, energy optimization module 124 may determine that since graphene-based supercapacitors have unique “signatures of performance” based upon pre measurements above that are different than lead-acid batteries or lithium-ion batteries, the unique “signatures of performance” using the energy optimization module 124 may make the driving experience of the electric vehicle using the graphene-based supercapacitors to be a least the same if not better experience than if the electric vehicle used lead-acid batteries or lithium-ion batteries. Such prediction may indicate that the electric vehicle is less likely to have battery failures, batteries lose power uphill, batteries run out when traveling.

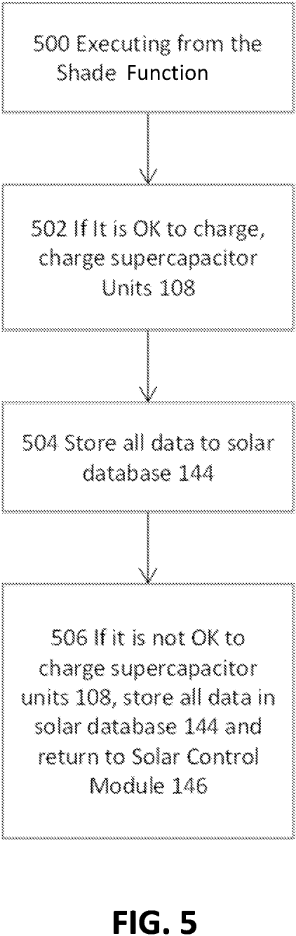

Further, the base module 122 may include a charging module 126, configured to evaluate the charging requirement of each of the plurality of supercapacitor units of ESU 108. The charging module 126 is described in conjunction with FIG. 5. In one embodiment, the charging module 126 may be activated and deactivated automatically by the base module 122 upon receiving a request from the energy optimization module 124 related to the requirement of the electric charge to drive the electric vehicle system 102. For example, if there are enough battery units with enough charge for running the electric vehicle at certain speeds for a certain amount of time (average power consumption), the charging module 126 is deactivated. If the electric vehicle at certain speeds for a certain time (average power consumption) is not available, the charging module 126 is activated.

In one embodiment, the charging module 126 may be configured to retrieve data related to each of the plurality of supercapacitor units of ESU 108 from the energy management database 104. In one embodiment, the data related to each of the plurality of the supercapacitor units of ESU 108 may correspond to an amount of electric charge stored in each of the plurality of supercapacitor units of ESU 108. In another embodiment, the charging module 126 may be configured to analyze and compare the data retrieved from the energy management database 104 concerning the data related to each of the plurality of supercapacitor units of ESU 108. Charging module 126 may determine whether charging is needed or not.

The base module 122 may include a maintenance module 128 to maintain the electric vehicle system 102. In one embodiment, the maintenance module 128 may be configured to run internal maintenance of the electric vehicle system 102 and the plurality of supercapacitor units of ESU 108 after the base module 122 receives a notification from the charging module 126. Further, the maintenance module 128 may determine whether the electric vehicle system 102 is consuming the electric charge more than the desired charge for a particular run time, where a maintenance check may be needed. In one embodiment, the maintenance module 128 may raise a maintenance request to the base module 122, indicating that the plurality of supercapacitor units of ESU 108 is not coupled correctly. The electric vehicle system 102 is experiencing more load while driving over the predefined path. Further, the maintenance module 128 may determine the performance of the electric vehicle system 102 for retrieved performance from the design database 120 and the energy management database 104. In another embodiment, the maintenance module 128 may perform an internal maintenance check-up to determine whether each component of the electric vehicle system 102 is functioning up to its desired requirement.

The maintenance module 128 determines when the ESU 108 requires maintenance, either per a predetermined scheduled or when needed due to apparent problems in performance, as may be flagged, or in issues about safety as determined by the safety module based on data from sensors or the charging/discharging hardware, and in light of information from the energy sources modules. The maintenance module 128 may cooperate with the communication module 134 to provide relevant information to the display interface and the message center. An administrator or owner may initiate maintenance action in response to the message provided. The maintenance module 128 may also initiate mitigating actions to be taken, such as cooperating with the charge/discharge module to decrease the demand on one or more of the power packs in need of maintenance and may also cooperate with the configuration module to reconfigure the power packs to reduce the demand in components that may be malfunctioning of near to malfunctioning to reduce harm and risk.

Further, the base module 122 may include a speed optimization module 130 configured to provide the predefined path of the electric vehicle system 102. The speed optimization module 130 may also be referred to as a range optimization module in one embodiment. Further, the speed optimization module 130 may enhance the performance of the electric vehicle system 102 by minimizing the consumption of electric charge. In one embodiment, the speed optimization module 130 may be configured to provide a road map for the electric vehicle system 102. In one embodiment, the road map may be a graph or a curve with anticipated acceleration and deceleration points along the predefined path with areas where the drain is used and where it is not (hills drain batteries a lot and valleys drain the battery far less ). Therefore, the electric vehicle system 102 may consume electric charge only when accelerating over a steep curve and may stop the flow of the electric charge while moving downwards on a steep curve. Further, the speed optimization module 130 may retrieve information related to maintenance of the electric vehicle system 102 from the design database 120 to measure the amount of electric charge consumed by the electric vehicle system 102 before maintenance.

Further, the base module 122 may include a control module 132 configured to determine the best use of the electric charge from the plurality of supercapacitor units of ESU 108. In one embodiment, the controller module 132 may be configured to retrieve information related to the ideal consumption of the electric charge of the electric vehicle system 102 from the energy management database 104. Further, the controller module 132 may use information from the energy optimization module 124, the charging module 126, the maintenance module 128, and the speed optimization module 130 to determine the best use of the electric charge. For example, the controller module 132 retrieves from the energy management database 104 that the electric vehicle system 102 should consume 3 kWh per kilometer of electric charge. However, the maintenance module 128 and the speed optimization module 130 provide information that the electric vehicle system 102 is consuming 4 kWh per kilometer of electric charge. Therefore, the controller module 132, using the anticipated acceleration and deceleration map, can determine the best use of the electric charge to manage overall watt-hour energy over time. Further, the controller module 132 may be configured to effectively manage the plurality of supercapacitor units of ESU 108 in series or parallel.

Communications module 134 covers internal messaging and control data internally and messaging to the user using the display interface 114. In one embodiment, the base module 122 may include a communication module 134 configured to facilitate communication between the base module 122 and the plurality of supercapacitor units of ESU 108. Further, the base module 122 may determine the number of supercapacitor units being used in the electric vehicle system 102 in real-time. In one embodiment, the communication module 134 may be configured to provide an exact figure for connections of the supercapacitor units of ESU 108 for the plurality of supercapacitor units of ESU 108, which continuously supply electric charge to the electric vehicle system 102.

Further, the base module 122 may include a health and safety module 136, which may be configured to provide health and safety-related to the user related to the safety of the battery (danger of fire or explosion) of the electric vehicle system 102. For example, a user may experience health-related problems while driving the electric vehicle, such as batteries getting near and an over-temperature setting, which can be displayed using the display interface 114.

Further, the electric vehicle system 102 may be provided with the security module 138 to measure continuously the plurality of supercapacitor units of ESU 108 installed within the electric vehicle system 102. The security module 138 may also evaluate and warn users how external charging hookups may be configured. The security module 138 helps reduce the risk of counterfeit products or theft or misuse of legitimate products associated with the ESU 108, thus including one or more methods for authenticating the nature of the ESU 108 and authorization to use it with the device in question. Methods of reducing the risk of theft or unauthorized use of an ESU 108 or its respective power packs can include locks integrated with the casing of the ESU 108 that mechanically secure the ESU 108 in the electric vehicle or other devices, wherein a key, a unique fob, a biometric signal such as a fingerprint or voice recognition system, or other security-related credentials or may be required to enable removal of the ESU 108 or even operation thereof.

In another aspect, the security module 138 provides and tracks a unique identifier (not shown) that can be tracked, allowing a security system to verify that a given ESU 108 is authorized for use with the device, such as an electric vehicle or other devices. For example, the casing of the ESU 108 or one or more power packs therein may have a unique identifier attached, such as an RFID tag with a serial number (an active or passive tag), a holographic tag with unique characteristics equivalent to a serial number or password, nanoparticle markings that convey a unique signal, etc. One good security tool that may be adapted for the security of the ESU 108 is a seemingly ordinary bar code or QR code with unique characteristics not visible to the human eye that cannot be readily copied, is the Unisecure™ technology offered by Systech (Princeton, NJ), a subsidiary of Markem-Image, that essentially allows ordinary QR codes and barcodes to become unique, individual codes by analysis of tiny imperfections in the printing to uniquely and robustly identify every individual product, even if it seems that the same code is printed on each one.

Security module 138 relies at least in part on the unique electronic signature of the ESU 108 and one or more individual power packs or of one or more supercapacitor units therein. The principle will be described relative to an individual power pack but may be adapted to an individual supercapacitor or collectively to the ESU 108 as a whole. When a power pack that includes supercapacitors is charged from a low voltage or relatively discharged state, the electronic response to a given applied voltage depends on many parameters, including microscopic details of the electrode structure such as porosity, pore size distribution, and distribution of coating materials, or details of electrolyte properties, supercapacitor geometry, etc., as well as macroscopic properties such as temperature. At a specified temperature or temperature range and under other suitable macroscopic conditions (e.g., low vibration, etc.), the characteristics of the power pack may then be tested using any suitable tool capable of identifying a signature specific to the individual power pack. Such techniques may include impedance spectroscopy, cyclic voltammetry, etc., measured under conditions such as Cyclic Charge Discharge (CCD), galvanostatic charge/discharge, potentiostatic charge/discharge, and impedance measurements, etc. An electronic signature of time effects (characteristic changes in time of voltage or current, for example, is a response to an applied load of some kind) may be explored for a specified scenario such as charging a 90% discharged power pack to a state of 50% charge (or other predetermined threshold or range), or examining the response to different applied voltages such as -3 V to +4 V. Voltammograms may be obtained showing, for example, the response of the power pack to different scan rates.

The security module 138 recognizes that the details of supercapacitor response to a specific load or charge/discharge process may vary gradually over time, especially if the supercapacitor has been exposed to excess voltage or other mechanical or electrical stress can be adaptive and recognize and accept change within certain limits. Changes observed in the response characteristics can be used to update a security database or performance database for the ESU 108 so that that future authentication operations will compare the measured behavior profile of the power pack of the ESU 108 in question with the updated profile for authentication purposes and for tracking of performance changes over time. Such information may also be shared with the maintenance module, including the maintenance database, which may trigger a request or requirement for service if there are indications of damage pointing to the need for repair or replacement. When a power pack or supercapacitor therein is replaced due to damage, the response profile of the power pack can then be updated in the security database. When such physical changes cause changes to the measured electronic characteristics that exceed a reasonable threshold, the authorization for the use of that ESU 108 may be withdrawn pending further confirmation of authenticity or necessary maintenance.

In another aspect, each ESU 108 and optionally each power pack of the ESU 108 may be associated with a unique identifier registered in a blockchain system, and each “transaction” of the ESU 108 such as each removal from a vehicle, maintenance operations, purchase or change in ownership, and installation into a vehicle or other device can be recorded and tracked. A code, RFID signal, or other identifiers may be read or scanned for each transaction, such that the blockchain record may then be updated. The blockchain record may include information about the authorization state of the product, such as information on what vehicle or vehicles or products the ESU 108 is authorized for, or an identifier associated with the authorized user may be provided, which can be verified or authenticated when the ESU 108 is installed in a new setting or when a transaction occurs. The authorization record may be updated at any time, including when a transaction occurs. The vendor may provide mechanisms to resolve disputes regarding authorization status or other questions.

In some aspects, such as in military or government operation, the ESU 108 may include an internal “kill switch” or other inactivation devices that authorities can remotely activate in the event of a crime, unauthorized use, or violation of a contract. Alternatively, an electric vehicle or other devices may be adapted to reject the installation of an ESU 108 that is not authorized for use in the vehicle or device.

Further, the base module 122 may include a motor control module 140 to enhance the performance of the vehicle motor of the electric vehicle system 102. In one embodiment, the motor control module 140 may be configured to evaluate the performance of the vehicle motor in at least two modes. In one embodiment, the two modes may be an enhanced torque mode and an economy mode. Further, the enhanced torque mode may be employed when the electric vehicle system 102 moves up a hill or the steep curve of the road upwards. In one embodiment, the motor consumes more electric charge to generate more torque for moving the electric vehicle system 102 upwards. Further, the economy mode may be initiated when the electric vehicle system 102 moves down the hill. The less electric charge needs to drive the electric vehicle system 102 downwards or when the electric vehicle system 102 is extending beyond the run time. In one embodiment, the motor control module 140 may be configured to monitor and anticipate the performance of the motor according to the enhanced torque mode or the economy mode. Further, the motor control module 140 may retrieve data related to parameters affecting the movement of the electric vehicle system 102 over the path from the energy management database 104 and the design database 120. In one embodiment, the data may include but is not limited to weather, length of the day, length of a golf course.

Solar control module 142 may operate in conjunction with base module 122 and solar hardware & controller 146 to control all aspects of solar charging supercapacitor units of ESU 108 based upon geolocation predictions, shade detection, and other factors. Solar control module 142 may further be executable to generate and deliver alerts to one or more designated recipient devices.

Solar database 144 allows for storing and reading all solar data by timestamp, including but not limited to (1) geolocation data, (2) shade data, (3) solar energy output data, (4) initiative authority of whether to charge, supercapacitor units 108 charging data, etc.

Solar hardware & controller 146 may be inclusive of solar panels and solar cells, as well as controllers for controlling operations of such solar panels and cells. Solar hardware & controller 146 may be configured to poll solar cells regarding energy output, as well as provide data to solar database 144 for storage.

Solar panels produce electrical power through the photovoltaic effect, converting sunlight into DC electricity. This DC electricity may be fed to a battery via a solar regulator to ensure proper charging and prevent damage to the battery. While DC devices can be powered directly from the battery or the regulator, AC devices require an inverter to convert the DC electricity to suitable AC at, for example, 110 V, 120 V, 220 V, 240 V, etc. Solar panels of solar hardware & controller 146 may be wired in series or in parallel to increase voltage or current, respectively. The rated terminal voltage of a 12 Volt solar panel maybe around 17 Volts, but the regulator may reduce the voltage to a lower level required for battery charging.

Solar hardware & controller 146 may further include solar regulators (also called charge controllers), which regulate current from the solar panels to prevent battery overcharging, reducing or stopping current as needed. Solar regulators may also include a Low Voltage Disconnect feature to switch off the supply to the load when the battery voltage falls below the cut-off voltage and prevent the battery from sending charge back to the solar panel in the dark.

Regulators of solar hardware & controller 146 may operate with a pulse width modulation (PWM) controller, in which the current is drawn out of the panel at just above the battery voltage, or with a maximum power point tracking (MPPT) controller, in which the current is drawn out of the panel at the panel “maximum power voltage,” dropping the current-voltage like a conventional step-down DC-DC converter but adding the “smart” aspect of monitoring of the variable maximum power point of the panel to adjust the input voltage of the DC-DC converter to deliver optimum power.

Solar hardware & controller 146 may further includes inverters, which are devices that convert DC power to AC electricity. They come in several forms, including on-grid solar inverters that convert the DC power from solar panels into AC power which can be used directly by appliances or be fed into the grid. Off-grid systems and hybrid systems can also provide power to batteries for energy storage but are more complex and costly than on-grid systems, requiring additional equipment. An inverter/charger that manages both grid connection and the charging or discharging of batteries may be an interactive or multi-mode inverter. A variation of such inverters is known as the all-in-one hybrid inverter.

Output from inverters may be in the form of a pure sine wave or a modified sine wave or a square wave. Some electronic equipment may be damaged by the less expensive modified sine wave output. Multiple solar panels are connected to a single inverter in a “string inverter” setup in many conventional systems. This can limit system efficiency, for when one solar panel is shaded and has reduced power, the overall current provided to the inverter is likewise reduced. String solar inverters are provided in single-phase and three-phase versions. Microinverters are miniature forms of inverters that can be installed on the back of individual solar panels, providing the option for AC power to be created directly by the panel. For example, LG (Seoul, Korea) produces solar panels with integrated microinverters. Unfortunately, microinverters limit battery charging efficiency, for the AC power from the panels must be converted back to DC power for battery charging. They also add high costs to the panels. The additional equipment on the panel may also increase maintenance problems and possibly the risk of lightning strikes. Microinverters generally use maximum power point tracking (MPPT) to optimize power harvesting from the panel or module connected to it. An example of a microinverter is the Enphase M215 of Enphase Energy (Fremont, CA).

The on-grid string solar inverters and microinverters, collectively called solar inverters, provide AC power that can be fed to the grid or directly to a home or office. Alternatively, off-grid inverters (or “battery inverters”) or hybrid inverters can charge batteries. Hybrid inverters can charge batteries with DC and provide AC for the grid or local devices, combining a solar inverter and battery inverter/charger into a single unit. An example of a hybrid inverter is the Conext SW 120/240 VAC hybrid inverter charger 48 VDC (865-4048) by Schneider Electric (Rueil-Malmaison, France) is a 4 kW (4000 watts) pure sine wave inverter or the 2.3 kW Outback Power Hybrid On/Off-grid Solar Inverter Charger 1-Ph 48 VDC by Outback Power (Phoenix, AZ). Solar power systems may employ “deep cycle solar batteries” designed for discharge over a long time (e.g., several days). Such batteries may be at risk of permanent damage if highly discharged, such as below 30% capacity. They also may suffer the drawback of delivering less total charge at a high load than at a low load due to overheating problems at elevated discharge rates.

Solar module 148 may be continuously executing while receiving solar data from the solar hardware & controller 146. The solar module 148 may poll the solar hardware & controller 146, and upon request, send data to solar hardware & controller 146, send charge data to charging module 126, or charge supercapacitor units of ESU 108. In some implementations, solar module 148 may also check for approval or for confirmation before charging the supercapacitor units of ESU 108. solar module 148 may be integrated with charging module 126 of base module 122 so as to allow charging from solar cells of solar hardware & controller 146. Together with charging module 126, solar module 148 may generate commands for solar hardware & controller 146 to connect to supercapacitor units 108 and to charge the supercapacitor units of ESU 108. Such commands may be generated when the predicted geolocation, sun-times, and intensity are evaluated and determined to be adequate and when it is determined that no shade is blocking the solar cells. There may be many reasons as to why the solar module 148 does not just continually charge the supercapacitor units 108, for example, but not limited to (1) the design of the lifetime of supercapacitors can be optimized for solar cell charging with the correct intensity and time of solar charging, (2) managing solar cell charging properly may make the predictions generated by processor 116 of the electric vehicle system 102 to be improved (improved energy optimization, improved maintenance, improved speed optimization, improved health and safety (not to overcharge the supercapacitor units 108) and (3) assisting the user to understand how sun and shade can affect charging so the user may optimize their driving behaviors.

Solar module 148 may further be executable to read geolocation data from a GPS unit associated with electric vehicle system 102, use the geolocation data to determine whether to charge supercapacitor units 108. In some implementations, solar module 148 may further be executable to read the shade level as assessed by one or more light sensors or other sensors. For example, solar module 148 may assess such sensor data to determine whether there is sufficient sun intensity to charge the supercapacitors. In other implementations, other sensors may detect that clouds are currently blocking sunlight or the electric vehicle (and its solar panels of solar hardware & controller 146) may be parked in a shady location. Solar module 148 may further be executable to determine that shade (based on one or more stored definitions, e.g., all solar cells being reduced in intensity by 50%) could be determined as shade. On the other hand, in some embodiments, shade may be determined as any of (1) solar cells’ energy fluctuations, or (2) some solar cells blocked and some solar cells not blocked. Solar module 148 may determine if there is too much shade to charge the supercapacitor unit 108, as well as determine whether to charge the supercapacitor unit 108.

The electric system vehicle 102 may also include a communication interface 150 and an associated configuration system to properly configure the ECS to communicate with the interface or other aspects of the vehicle and communicate with central systems or other vehicles when desired. In such cases, a fleet of vehicles may be effectively monitored and managed to improve energy efficiency and track the performance of vehicles and their ESUs, thereby providing information that may assist with maintenance protocols. Such communication may occur wirelessly or through the cloud communication network 106 via a communication interface 150, share information with various central databases 104, or access information from databases 104 to assist with the vehicle’s operation and the optimization of the ESU 108, for which historical data may be available in a database 104.

The communication interface 150 can govern communications between the electric vehicle system 102 and the outside world, including communications through the cloud communication network 106, such as making queries and receiving data from various external databases 106 or sending messages to a message center where they may be processed and archived by an administrator, a device owner, the device user, the ESU owner, or automated systems. In some aspects, the communication module may also oversee communication between modules or between the ESU and the ECS and work in cooperation with various modules to direct information to and from the display interface. Communications within a vehicle or between the ECS or ESU and the device may involve a DC bus or other means such as separate wiring. Any suitable protocol may be used, including UART, LIN (or DC-LIN), CAN, SPI, I2C (including Intel’s SMBus), and DMX (e.g., DMX512). In general, communications from the ECS or ESU with a device may be over a DC bus or, if needed, over an AC/DC bus, or by separately wired pathways if desired, or wireless. Proper transceivers for communicating over DC lines include, for example, the SIG family and DCB family of transceivers from Yamar Electronics, LTD (Tel Aviv, Israel), and Yamar’s DCAN500 device for CAN2.0 A/B protocol messages.

The network environment of FIG. 1 may further include an energy management database 104 communicatively coupled to the electric vehicle system 102 via a cloud communication network 106 or directly to the processor 116. In one embodiment, the energy management database 104 may be configured to provide historical data related to the electric vehicle system 102. In another embodiment, the energy management database 104 may provide a research report for an average charge consumption of the electric vehicle system 102 over a predefined path. In one embodiment, the energy management database 104 may store information related to solar charging, supercapacitor units, electric charge percentage, acceleration of motor, and electric charge in the supercapacitor units, as well as data for individual drivers, driving conditions (temperature, weather, time of year or day), power pack identity or characteristics, the mass of the vehicle and passengers and cargo (this may require load cells installed in the vehicle or an external device for weighing the vehicle), etc..

Further, embodiments may include a cloud communication network 106. Cloud communication network 106 may facilitate a communication link among the components of the network environment. Cloud communication network 106 may be a wired and a wireless network. The cloud communication network 106, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques, known in the art. In some embodiments, the cloud communication network 106 could be replaced by a “bus” to connect the processor 116 to any other controller or memory.

Instructions related to managing the plurality of supercapacitor units of ESU 108 may be stored in the energy management database 104. Further, a user may retrieve the store instructions from the energy management database 104 before driving the electric vehicle system 102. In one embodiment, the stored instructions may include but are not limited to the capacity of each of the plurality of supercapacitor units of ESU 108, amount of charge required for one trip of electric vehicle system 102 along the path, such as golf course, etc., charging required for a supercapacitor unit, and acceleration and deceleration data related to the path of the electric system vehicle 102. The energy management database 104 need not include details about the route and its characteristics, but may interact with a GPS, terrain database, or other sources of information to enable the needed computations.

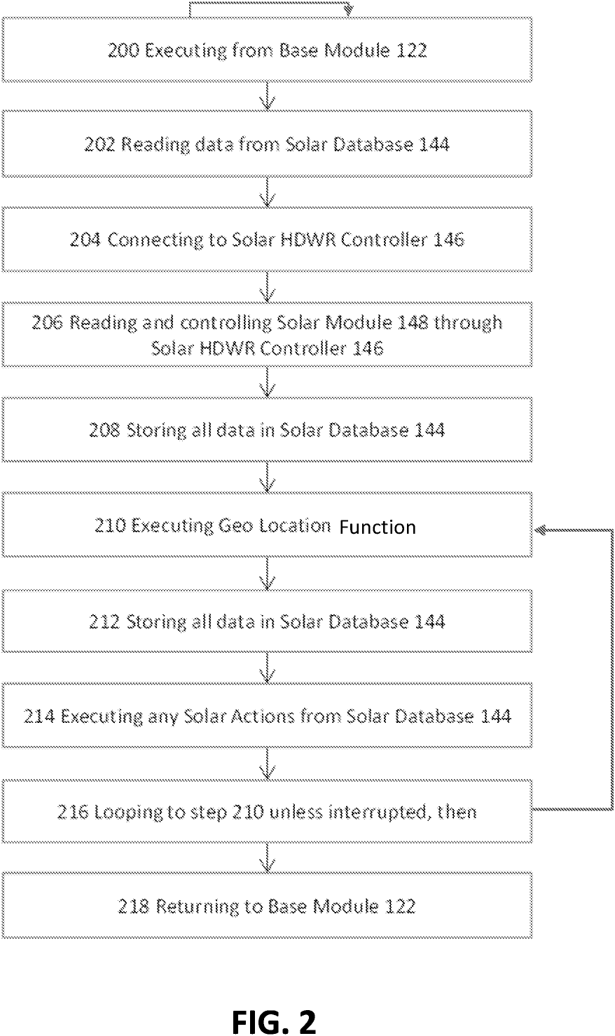

FIG. 2 is a flowchart illustrating an exemplary method for solar charging control. The method of 200 may be performed based on execution of the base module 122 by processor 116.

In step 200, base module 122 may call for solar control module 142 to be executed, which allows for control over all aspects of solar charging of supercapacitor units of ESU 108 based upon such factors as geolocation predictions, shade detection, and other factors. The solar control module 142 may further be executable to generate and deliver alerts to the user if needed.

In step 202, solar control module 142 may further be executable to read data from solar database 144. As noted above, solar database 144 allows for storing and reading all solar data by timestamp, including but not limited to (1) geolocation data, (2) shade data, (3) solar energy output data, (4) initiation authority of whether to charge, supercapacitor units 108 charging data, etc.

In step 204, solar control module 142 may further connect to solar hardware & controller 146, which allows the solar control module 142 to control (read and write data) to the solar hardware & controller 146. In step 206, solar control module 142 may further be executable to control solar module 148 through solar hardware & controller 146.

In step 208, all current data may be stored in the solar database 144. In step 210, a geolocation function of solar module 148 may be executed to identify current geolocation data for the electric vehicle system 102. Such geolocation data may also be stored in solar database 144 at step 212.

In step 214, solar control module 142 may further identify and generate instructions for solar actions identified from the stored information of solar database 144. For example, solar actions may include generating alerts about solar charging conditions. Solar database 144 may include various alert templates that may be used and triggered for display when certain conditions (e.g., when shade prevents charging). For an additional example, the solar database 144 may also contain an action to alert the user on the display interface 114 when the solar cells may be determined to be charging the supercapacitor units of ESU 108 for the next two hours. In step 216, the method may then loop back to step 210, unless interrupted, which may occur either in real-time or on a timed interval. The method may otherwise return to the base module 122 upon interruption at step 218.

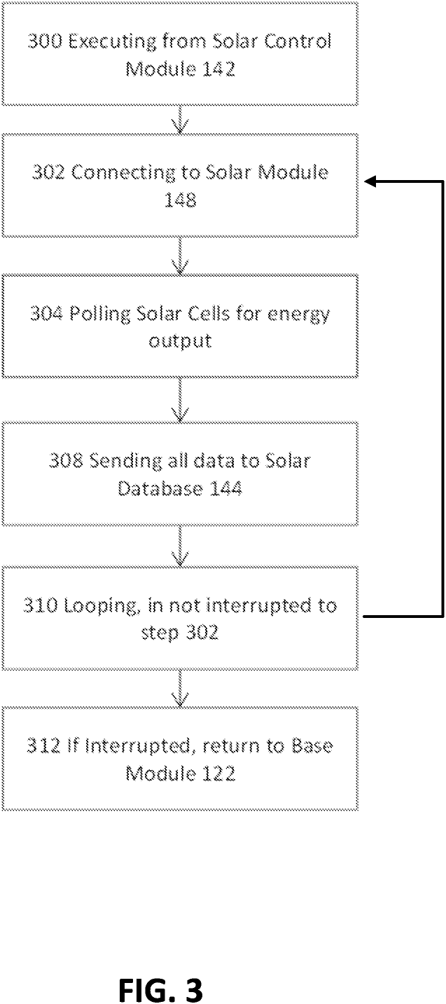

FIG. 3 is a flowchart illustrating an exemplary method for controlling solar hardware. The method of FIG. 3 may be performed based on execution of solar hardware & controller 146 by processor 116.

In step 300, the solar hardware & controller 146 may be executed or called by solar control module 142 of base module 122, and in step 302, solar hardware & controller 146 may connect to solar module 148.

In step 304, solar hardware & controller 146 may poll the solar cells for data regarding energy output. For example, the solar cells mounted on the electric vehicle system 102 may have a panel or set of panels where each panel may have multiple solar cells. Some solar cells may not read any out energy as there could be no sun out or blocked solar cells. This information may be used to determine whether to initiate a solar action (e.g., charging supercapacitor units of ESU 108), as well as generate instructions or recommendations for how to perform the solar action.

In step 306, solar hardware & controller 146 may store all data to solar database 144, and in step 310, the method may loop back to step 302 if not interrupted, either in real-time or on a timed interval. Where an interruption is detected, the method may return to base module 122 at step 312.

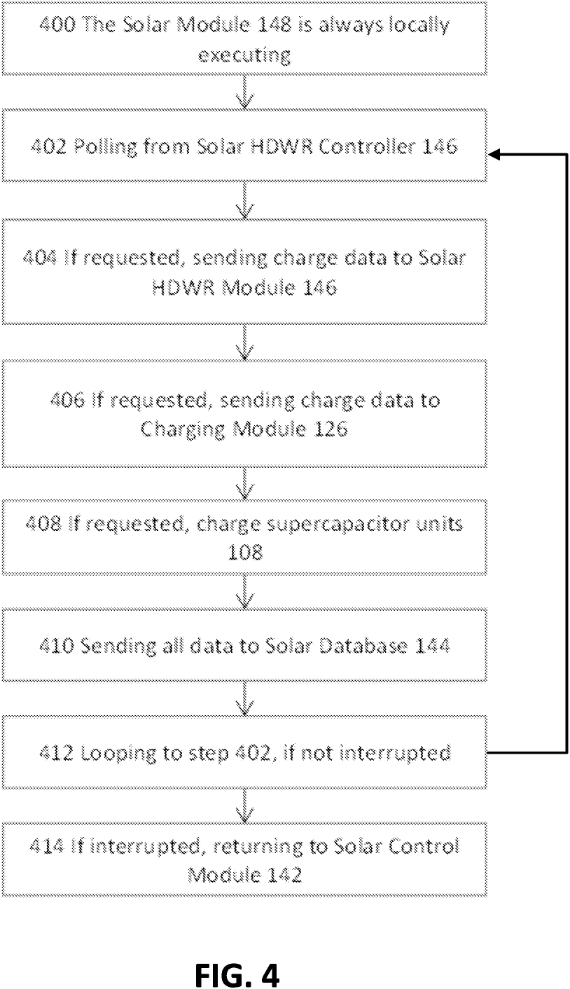

FIG. 4 is a flowchart illustrating an exemplary method for charging supercapacitors using solar cells. The method of FIG. 4 may be performed based on execution of solar module 148 by processor 116.

In step 400, the solar module 148 may be locally executed. By locally executing, the solar module 148 may run independently of all other processes and can be controlled by other processes when needed.

The solar module 148 may receive and send data to the solar hardware & controller 146 in response to polling in step 402. If requested, the solar module 148 may send data to solar hardware & controller 146 at step 404. If requested, the solar module 148 may further send charge data to charging module 126 at step 406. If requested, the solar module 148 may then charge supercapacitor units 108 at step 408.

In step 410, the solar module 148 may send all data to solar database 144. The method may then loop back to step 402, if not interrupted at step 412. If interrupted, however, the method may return to solar control module 142 at step 414. Interruption may be, for example, that other processes of the base module 122 take precedent. If interrupted, it is understood that base module 122 can reinitiate any process related to solar cell charging (not shown) at step 414.

FIG. 5 is a flowchart illustrating an exemplary method for solar charging. The method of FIG. 5 may be performed when processor 116 executes solar charging module 150.

In step 500, the solar charging module 150 may be executed via the shade function of solar module 148.

In step 502, the solar module 148 may check to see whether to charge the supercapacitor units 108. The charging module 126 of base module 122 may be integrated with the solar charging module 150 to allow and control solar cell charging of ESU 108. The charging module 126 and the solar module 148 may operate to generate commands for solar hardware & controller 146 to connect to and charge the supercapacitor units of ESU 108 from solar cells. The command may be generated based on predicted geolocation, sun-times, light intensity, and detected shade.

In step 504, solar module 148 may store all data to the solar database 144. The solar charging module 150 determines whether to charge supercapacitor units 108. If so, the storage charging module 150 stores all data in solar database 144 and returns control to the solar control module 143 at step 506.

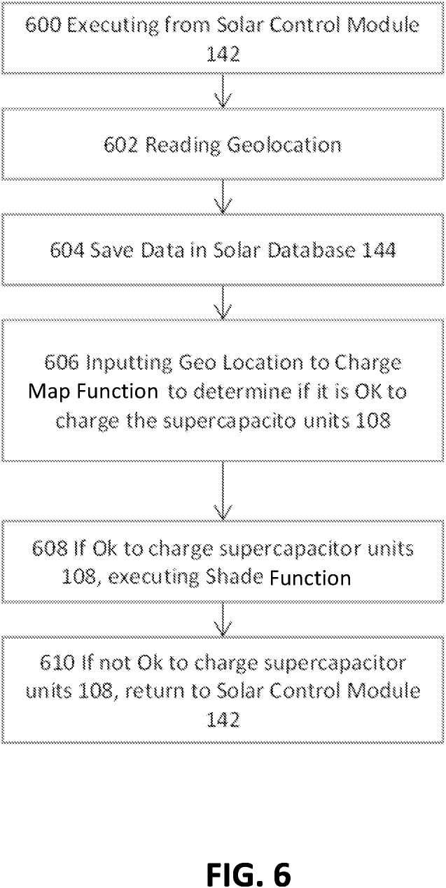

FIG. 6 is a flowchart illustrating an exemplary method for geolocation-based charging. The method of FIG. 6 may be performed when processor 116 executes a geolocation function of solar module 148.

In step 600, the geolocation function of solar module 148 may be executed or called by solar control module 142. The geolocation function of solar module 148 reads the geolocation from electric vehicle GPS at step 602.

The geolocation function of solar module 148 may save all data to the solar database 144 at step 604. The geolocation function of solar module 148 may further inputs geo-location data to charge map function. The charge map function may determine whether to charge supercapacitor units 108. For example, the charge map module may read the forecasted weather (not shown) to determine if the sun is projected to be out and its projected sunlight intensity. For example, if the sun may be out for the next 2 hours and the sun intensity is strong, whether to charge the supercapacitor unit 108. In some embodiments, charging the supercapacitors for 2 hours may be enough to supply enough energy to run the electric vehicle 102 and fully charge the supercapacitor unit 108. If it is determined that there is not enough sun time or intensity to charge the supercapacitor units 108, then an action may be generated to alert the user and displayed on the display interface 114.

The charge map function of solar module 148 may determine other times to charge the supercapacitor units of ESU 108, for example, at various predicted time intervals, various times of the day, etc., at step 606. The geo-location function of determines whether to charge supercapacitor units 108; if so, it executes the shade function of solar module 148 at step 608. The geo-location module 152 determines whether to charge supercapacitor units of ESU 108. If so, the method may return to the solar control module 142 at step 610.

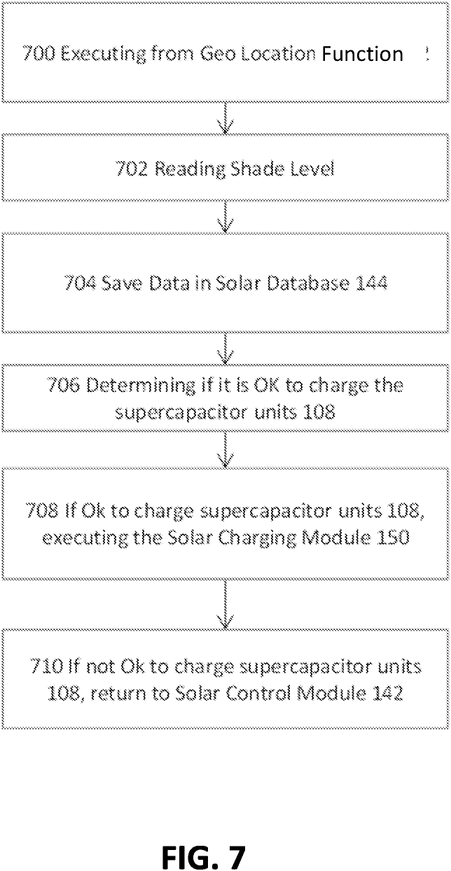

FIG. 7 is a flowchart illustrating an exemplary method for shade-based charging. The method of FIG. 7 may be performed when processor 116 executes a shade function of solar module 148.

In step 700, the shade function of solar module 148 executes from the geolocation function.

In step 702, the shade function of solar module 148 may then read the shade level or identify the shade level based on information from one or more sensors, including light sensors, cameras, and other sensors. For example, when the shade function of solar module 148 is called by the geolocation function, solar module 148 may analyze the sensor data to determine indications of light intensity. Such analysis may be based on historical data regarding light intensities and charging efficiency. On the other hand, in some embodiments, shade may be determined as any of (1) solar cells’ energy fluctuations, or (2) some solar cells blocked and some solar cells not blocked. The shade function of solar module 148 may determine if there is too much shade to charge the supercapacitor unit 108.

In step 704, the shade function of solar module 148 then saves the data in solar database 144. The shade function of solar module 148 may then determine whether to charge the supercapacitor unit 108 at step 706. The shade function of solar module 148 then determines whether to charge supercapacitor units of ESU 108.

Where it is determined to charge ESU 108, the shade function of solar module 148 then executes the solar hardware & controller 146 at step 708. Where the shade function of solar module 148 may determine not to charge supercapacitor units 108, the shade function of solar module 148 may then return to solar control module 142 at step 710.

When listing various aspects of the products, methods, or system described herein, it should be understood that any feature, element or limitation of one aspect, example, or claim may be combined with any other feature, element or limitation of any other aspect when feasible (i.e., not contradictory). Thus, power pack may include a temperature sensor and then a separate example of a power pack associated with an accelerometer would inherently disclose a power pack that includdes or is associated with an accelerometer and a temperature sensor.

Unless otherwise indicated, components such as software modules or other modules may be combined into a single module or component, or divided such that the function involves cooperation of two or more components or modules. Identifying an operation or feature as a discrete single entity should be understood to include division or combination such that the effect of the identified component is still achieved.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

What is claimed is:

1. A system for charging electric vehicle supercapacitors using solar energy, the system comprising:
memory that stores historical data regarding light intensity and solar actions;
one or more sensors configured to measure current light intensity in a surrounding environment of one or more solar panels;
a processor that executes instructions stored in memory, wherein the processor executes the instructions to:
analyze current light intensity measurements from the sensors;
determine whether to charge the supercapacitors based on the current light intensity; and
generates instructions regarding charging the supercapacitors using the solar panels; and
a communication interface that sends the instructions to a controller of the solar panels, wherein the controller executes the instructions to initiate charging of the supercapacitors using the solar panels.

2. The system of claim 1, wherein the communication interface further receives geolocation data from a global positioning system (GPS) of the electric vehicle, and wherein the instructions are further based on the geolocation data.

3. The system of claim 1, wherein the communication interface further receives weather data from a weather database over a communication network, and wherein the instructions are further based on the weather data.

4. The system of claim 1, wherein the processor analyzes the current light intensity measurements from the sensors to identify a current shade level.

5. The system of claim 4, wherein the processor identifies the current shade level based on a comparison to a predetermined light intensity threshold.

6. A method for charging electric vehicle supercapacitors using solar energy, the method comprising:
storing historical data in memory regarding light intensity and solar actions;
measuring current light intensity in a surrounding environment of one or more solar panels via one or more sensors;
executing instructions stored in memory, wherein the instructions are executed by a processor to:
analyze current light intensity measurements from the sensors;
determine whether to charge the supercapacitors based on the current light intensity; and
generates instructions regarding charging the supercapacitors using the solar panels; and
sending the instructions to a controller of the solar panels, wherein the controller executes the instructions to initiate charging of the supercapacitors using the solar panels.

7. The method of claim 6, wherein the communication interface further receives geolocation data from a global positioning system (GPS) of the electric vehicle, and wherein the instructions are further based on the geolocation data.

8. The method of claim 6, wherein the communication interface further receives weather data from a weather database over a communication network, and wherein the instructions are further based on the weather data.

9. The method of claim 6, wherein the processor analyzes the current light intensity measurements from the sensors to identify a current shade level.

10. The method of claim 9, wherein the processor identifies the current shade level based on a comparison to a predetermined light intensity threshold.

11. A non-transitory, computer-readable storage medium, having embodied thereon a program executable by a processor to perform a method for charging electric vehicle supercapacitors using solar energy, the method comprising:
storing historical data in memory regarding light intensity and solar actions;
measuring current light intensity in a surrounding environment of one or more solar panels via one or more sensors;
analyzing current light intensity measurements from the sensors;
determining whether to charge the supercapacitors based on the current light intensity;
generating instructions regarding charging the supercapacitors using the solar panels; and
sending the instructions to a controller of the solar panels, wherein the controller executes the instructions to initiate charging of the supercapacitors using the solar panels.
